(19) United States
(12) Patent Application Publication
(10) Pub. No.: US 2004/0210917 A1
(43) Pub. Date: Oct. 21, 2004

(54) Disc drive

(75) Inventor: Chun-Ting Chen, Tainan (TW)

Correspondence Address: QUINTERO LAW OFFICE, 1617 BROADWAY, 3RD FLOOR, SANTA MONICA, CA, 90404, US

(73) Assignee: BENQ Corporation

(21) Appl. No.: 10/824,534

(22) Filed: Apr. 14, 2004

(30) Foreign Application Priority Data
Apr. 15, 2003 (TW) 92108628

(51) Int. Cl. G11B 17/03

(52) U.S. Cl. 720/610

(57) ABSTRACT

A disc drive is disclosed. The disc drive comprises a tray, a bracket connected to the tray, a lever pivotally connected to the bracket, a latching member pivotally connected to the lever, a solenoid connected to the bracket and movably connected with the lever, a stopper engaged with the latching member to lock the tray, and a rail. The latching member has a first protrusive portion. The rail has a concave portion and a second protrusive portion. When the lever is forced to rotate the latching member, the latching member is apart from the stopper to eject the tray, and then the first protrusive portion of the latching member is pressed by the second protrusive portion of the rail so as to rotate the latching member and move the latching member and the lever back.

### BACKGROUND OF THE INVENTION

1. Field of the Invention

The present invention relates to a disc drive, and in particular to a disc drive having an auto-returnable latching member in the ejection mechanism thereof.

2. Description of the Related Art

As disclosed in U.S. Pat. No. 6,320,838, the ejection mechanism of a disc drive utilizes a solenoid, a coil spring, and a latching mechanism to lock or release a plunger loading a disc (as shown in FIGS. 3 & 4 of U.S. Pat. No. 6,320,838). The latching mechanism engages a shoulder of a necked down region on a push probe or other suitable instrument to lock the push rod. When the solenoid is enabled, the latching mechanism is released from the necked down region, and the pushrod moves outward by the coil spring. A larger space of the disc drive is required because the entire ejection mechanism is designed far from the plunger. Therefore, the ejection mechanism described above is not suitable for a small type disc drive.

As disclosed in U.S. Pat. No. 5,963,528, the ejection of a sub-chassis (tray) in a disc drive is controlled by a solenoid and a lock lever (as shown in FIG. 13 of U.S. Pat. No. 5,963,528). A claw portion of the solenoid hooks an engaging roller to lock the sub-chassis of the disc drive. When the solenoid is enabled, the lock lever is released from the engaging roller to eject the sub-chassis. Although the ejection mechanism can be positioned on the sub-chassis and only a small space is required, users need to exert a force to overcome the magnetic force of the solenoid for moving the sub-chassis back. This results in inconvenient operation.

Hence, there is a need for an ejection mechanism, suitable for a small disc drive and providing more convenient operation.

### SUMMARY OF THE INVENTION

Accordingly, an object of the invention is to provide a disc drive having an auto-returnable latching member in the ejection mechanism thereof.

The disc drive of the invention includes a tray, a bracket connected to the tray, a lever pivotally connected to the bracket, a latching member pivotally connected to the lever, a solenoid connected to the bracket and movably connected with the lever, a stopper engaged with the latching member to lock the tray, and a rail. The latching member has a first protrusive portion. The rail has a concave portion and a second protrusive portion. The latching member is rotated in a first direction independently but accompanied by the lever when rotating in a second direction. When the lever is forced to rotate the latching member in the first direction, and the latching member is disengaged from the stopper to eject the tray. Further, the first protrusive portion of the latching member is pressed by the second protrusive portion of the rail so as to rotate the latching member in the second direction and move the latching member and the lever back.

The disc drive of the invention further comprises a torsion spring mounted on the lever, wherein one end of the torsion spring abuts the latching member to move the latching member back after the latching member is disengaged from the stopper. The lever is not moved with the latching member when the latching member rotates in the first direction to disengage from the stopper for releasing the tray. In addition, the latching member rotates in the second direction because of the torsion spring, the second protrusive portion presses the first protrusive portion so as to move the lever and the latching member back.

The latching member in the disc drive of the invention rotates independently away from the stopper to release and eject the tray, and the second protrusive portion pushes the first protrusive portion to rotate the latching member back upon ejection. This provides the disc drive with a function of emergent ejection when the solenoid fails. A probe or other suitable instrument may be inserted to push the latching member to eject the tray manually.

The disc drive of the invention further comprises a compression spring fixed to the lever in one end and contacted the tray in the other end, the lever is pressed by the compression spring as the lever is disconnected with the solenoid, and the lever rotates the latching member so as to disconnect the latching member and the stopper.

The rail in the disc drive of the invention has a concave portion adjacent to the second protrusive portion such that the first protrusive portion is moved along the concave portion and then pressed against the second protrusive portion to move the latching member and the lever back. Further, the lever and the latching member are pivotally connected on the bracket by a fastener.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein;

FIG. 1 is a perspective view of the disc drive in the invention;

FIG. 2 is a partially enlarged view of the disc drive in the invention;

FIG. 3 is an exploded view of the disc drive in the invention;

FIGS. 4a to 4d are top views of the ejection mechanism in the invention during normal ejection;

FIG. 4a-1 is a side view of the ejection mechanism in the invention; and

FIGS. 5a to 5d are top views of the ejection mechanism in the invention for an manual ejection.

### DETAILED DESCRIPTION OF THE INVENTION

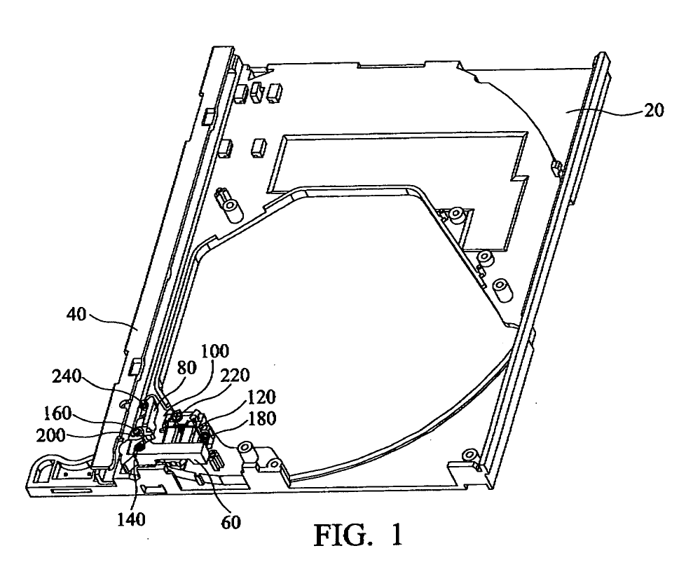

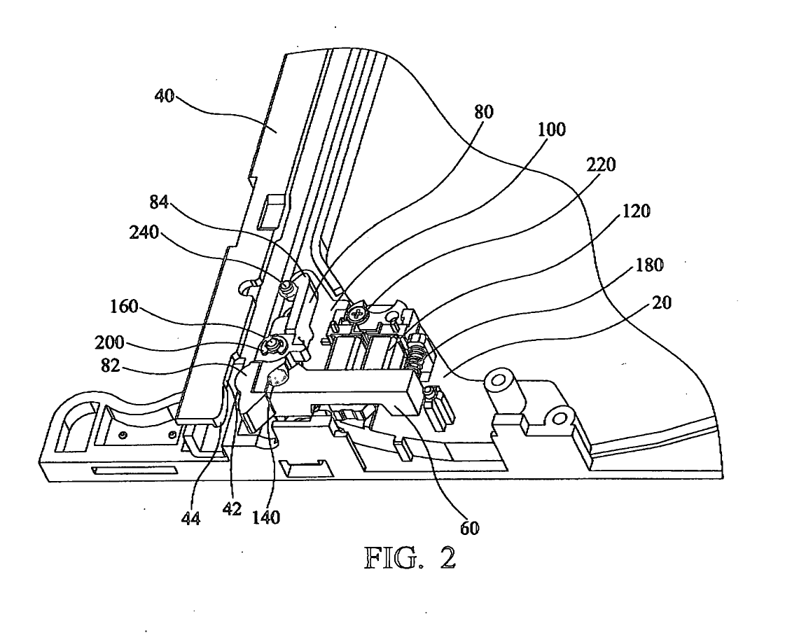

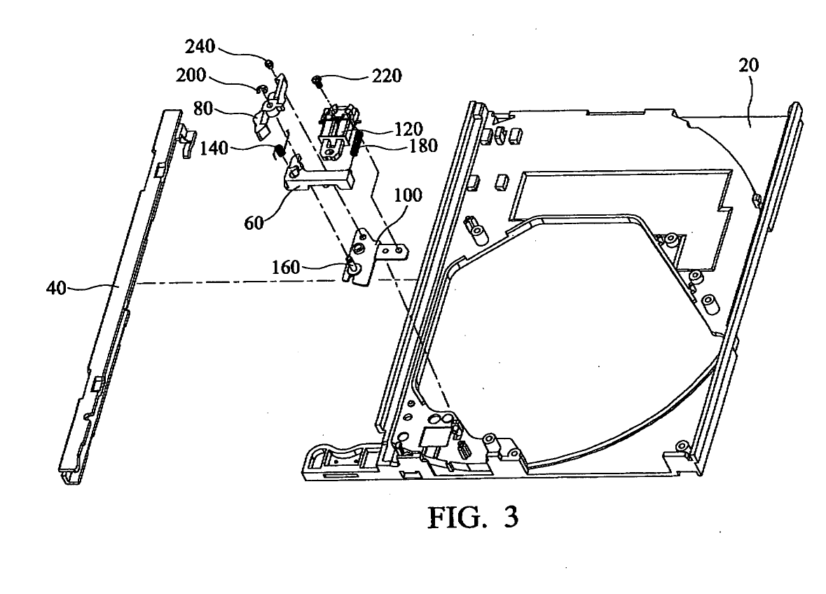

As shown in FIGS. 1, 2 & 3, the disc drive having an ejection mechanism in the invention is disclosed. The ejection mechanism is mounted on the front of a tray 20. A bracket 100 is connected to the tray 20. A lever 60 and a latching member 80 are pivoted together around a pin 160 on the bracket 100 by a fastener 200. In this embodiment, the latching member 80 can be rotated in a first direction (clockwise direction) independently but are accompanied by the lever 60 when rotating in a second direction (counterclockwise direction). The latching member 80 further includes a first protrusive portion 82. A solenoid 120 movably connected to the lever 60 is secured on the bracket 100 by a screw 220. Furthermore, the disc drive with the ejection mechanism further includes a stopper 240, a rail 40, a torsion spring 140 and a compression spring 180. The stopper 240 and the rail 40 provided for the tray 20 to slide thereon are not positioned on the tray 20. The torsion spring 140 is fixed on the lever 60. One end of the torsion spring 140 abuts the latching member 80. The latching member 80 rotates back by the force of the torsion spring 140 after a clockwise independent rotation. One end of the compression spring 180 is fixed on the lever 60 and the other end thereof contacts the tray 20.

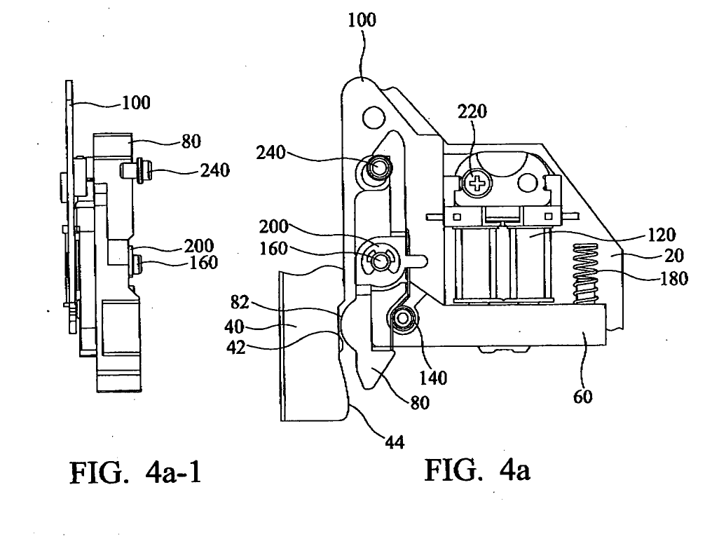

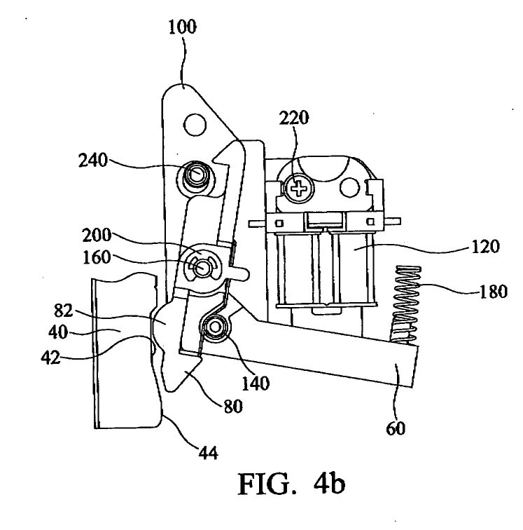

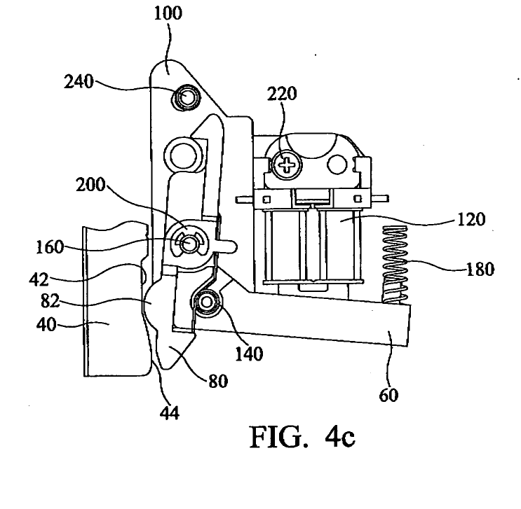

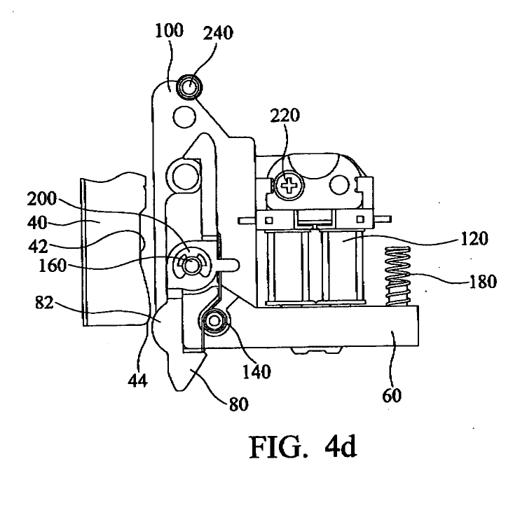

FIGS. 4a to 4d show the movement of the ejection mechanism of the tray 20 when a eject button (not shown) is pressed. FIG. 4a-1 is a side view of the ejection mechanism in FIG. 4a.

The latching member 80 hooks the stopper 240, as shown in FIG. 4a, when the tray 20 is positioned inside the disc drive. Before the tray 20 is ejected, the solenoid 120 is enabled to disconnect the lever 60, as shown FIG. 4b. In the same time, the compression spring 180 pushes the lever 60 and then pushes the latching member 80. Thereby, the latching member 80 rotates in a first direction 1 (clockwise) and disengaged from the stopper 240 to eject the tray 20. The rail 40 has a concave portion 42 and a second protrusive portion 44, and the concave portion is adjacent to the second protrusive portion 44.

When the tray 20 is ejected out of the disc drive, the force provided by the torsion spring 140 can rotate the latching member 80 in a second direction 2 (counter clockwise), as shown in FIG. 4c. In the same time, the first protrusive portion 82 moves along the concave portion 42 and then presses against the second protrusive portion 44 to rotate the latching member 80 and lever 60 as well as move the lever 60 back to the original position to connected with the solenoid 120, as shown in FIG. 4d. Since the solenoid 120 returns to its initial condition during ejection, no extra force is needed to overcome the magnetic force of the solenoid 120 when the user pushes the opened tray 20 back, and an improved and easier operation is achieved.

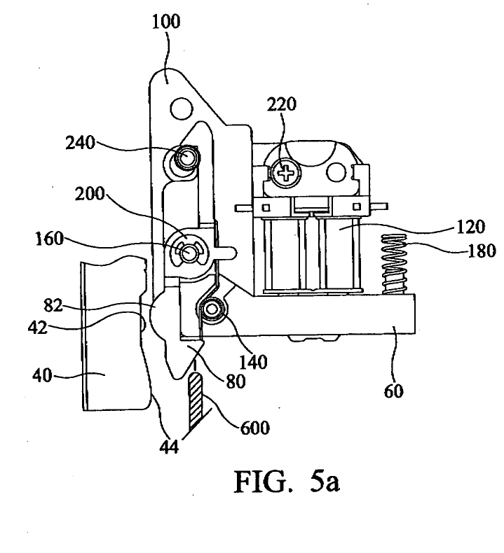

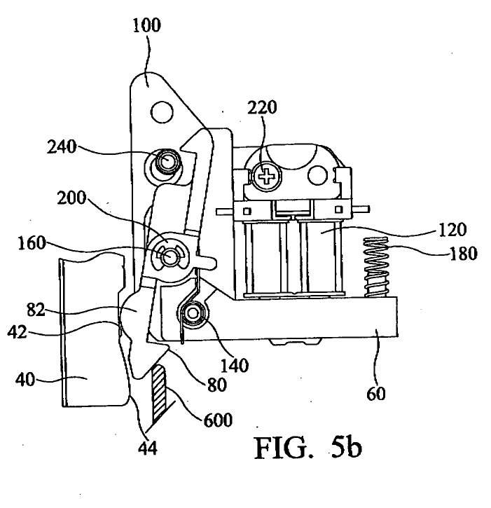

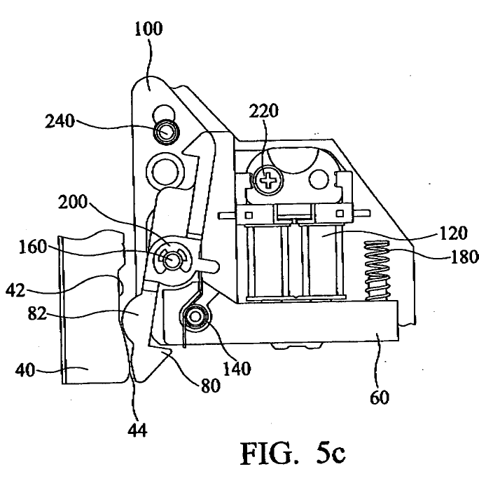

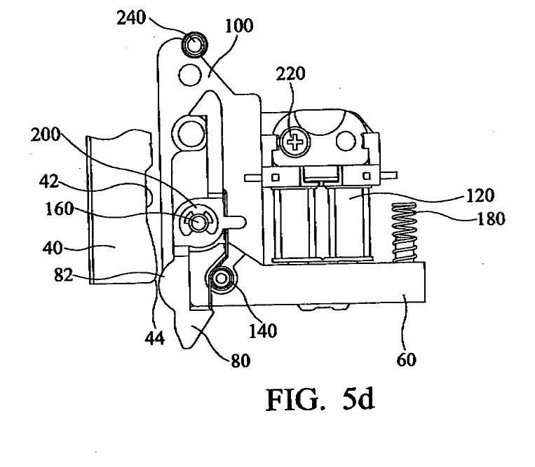

When the solenoid 120 is malfunctioned or other conditions occur to disable normal ejection of the tray 20, a thin probe or other suitable instrument 600 can be inserted into the disc drive to eject the tray 20 manually. FIGS. 5a to 5d show this manual ejection of the tray 20.

As shown in FIG. 5a & 5b, the thin probe or other suitable instrument 600 is inserted to rotate the latching member 80 in the clockwise direction, and then move the latching member 80 away from the stopper 240, thereby releasing and ejecting the tray 20. Because of the force provided by the torsion spring 140, the latching member 80 is also rotated back after the second protrusive portion 44 of the latching member presses against the first protrusive portion 82 of the rail 40 as described above (shown in FIGS. 5c & 5d). Since the solenoid 120 is not enabled in this manual ejection, users can also push the opened tray back easily without extra force to overcome the magnetic force of the solenoid 120.

Thus, the invention provides a disc drive having an auto-returnable latching member in the ejection mechanism thereof, allowing more convenient operation for users than conventional ejection mechanisms as well as structure and function better suited for use with small disc drives.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A disc drive, comprising;
a tray;
a bracket connected to the tray;
a lever pivotally connected to the bracket;
a latching member pivotally connected to the lever and having a first protrusive portion, the latching member being rotated in a first direction independently but accompanied by the lever when rotating in a second direction;
a solenoid connected to the bracket and movably connected to the lever;
a stopper engaged with the latching member to lock the tray;
a rail having a second protrusive portion,
wherein the lever is forced to rotate the latching member in the first direction, the latching member is disengaged from the stopper to eject the tray, and then the first protrusive portion of the latching member is pressed by the second protrusive portion of the rail so as to rotate the latching member in the second direction and move the latching member and the lever back.

2. The disc drive as claimed in claim 1 further comprising a torsion spring mounted on the lever, wherein one end of the torsion spring abuts the latching member to move the latching member back after the latching 5 member rotates in the first direction.

3. The disc drive as claimed in claim 2, wherein the latching member rotates in the first direction to disengage from the stopper for releasing the tray, the lever is not moved with the latching member.

4. The disc drive as claimed in claim 2, wherein the latching member rotates in the second direction because of the torsion spring, the second protrusive portion presses the first protrusive portion so as to move the lever and the latching member back.

5. The disc drive as claimed in claim 1 further comprising a compression spring fixed to the lever in one end and contacted the tray in the other end, the lever is pressed by the compression spring as the lever is disconnected with the solenoid, and the lever rotates the latching member so as to disconnect the latching member and the stopper.

6. The disc drive as claimed in claim 1, wherein the rail has a concave portion adjacent to the second protrusive portion such that the first protrusive portion is moved along the concave portion and then pressed against the second protrusive portion to move the latching member and the lever back.

7. The disc drive as claimed in claim 1, wherein the lever and the latching member are pivotally connected on the bracket by a fastener.
